(19) United States
(12) Patent Application Publication
(10) Pub. No.: US 2018/0324831 A1
(43) Pub. Date: Nov. 8, 2018

(54) Apparatus and Method for Puncturing Data Transmissions Due to Higher Priority Data

(71) Applicant: NOKIA TECHNOLOGIES OY, Espoo (FI)

(72) Inventors: Frank FREDERIKSEN, Klarup (DK); Jens STEINER, Klarup (DK); Klaus Ingemann PEDERSEN, Aalborg (DK)

(21) Appl. No.: 15/764,844

(22) PCT Filed: Sep. 27, 2016
(86) PCT No.: PCT/IB2016/055779

§ 371 Date: Mar. 29, 2018

Related U.S. Application Data
(60) Provisional application No. 62/235,723, filed on Oct. 1, 2015.

(51) Int. Cl. H04W 72/12; H04L 1/18

(52) U.S. Cl. CPC H04W 72/1242; H04L 1/1812

(57) ABSTRACT

One embodiment is directed to a method comprising receiving a grant message for channel resource allocation from a scheduling node, receiving data transmission based on the allocated channel resource from the scheduling node, and receiving a confirmation message from the scheduling node that indicates which channel resource was actually used for the data transmission. Another embodiment is directed to a method comprising receiving a grant message for channel resource allocation, receiving data transmission based on the allocated channel resource, decoding the received data, if the received data cannot be decoded correctly, sending an indication of packet failure, receiving a retransmission grant message, receiving a retransmitted data, and based on the retransmission grant message, performing HARQ combining.

### CROSS-REFERENCE TO RELATED APPLICATION

This application is related to and claims the benefit and priority of U.S. Provisional Patent Application No. 62/235,723, filed Oct. 1, 2015, the entirety of which is hereby incorporated herein by reference.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP). Since its inception, LTE has seen extensive deployment in a wide variety of contexts involving the communication of data. In recent years, the exponential growth of smartphones and the traffic they generate have become a major challenge of the industry. 3GPP has been continuing to alleviate this challenge by enhancing LTE standards to further improve capacity and performance and introducing improvements for system robustness.

### SUMMARY

According to a first embodiment, a method may include receiving a grant message for channel resource allocation from a scheduling node; receiving data transmission based on the allocated channel resource from the scheduling node; and determining whether the data transmission has been punctured.

In a variant, the method can also include receiving a confirmation message from the scheduling node that indicates which channel resource was actually used for the data transmission, wherein determining whether the data transmission has been punctured comprises determining based on the received confirmation message.

In a variant, the method can also include decoding the received data transmission; if the received data is not decoded correctly, sending an indication of packet failure to the scheduling node; and receiving a retransmission grant message that indicates which part of channel resource previously granted was not used for the data transmission, wherein determining whether the data transmission has been punctured comprises determining based on the received retransmission grant message.

In a variant, the method can also include receiving retransmitted data and performing hybrid automatic repeat request combining based on the retransmission grant message.

In a variant, the retransmission grant message assigns only previously punctured channel resource as retransmission resource.

According to a second embodiment, a method may include transmitting a grant message for channel resource allocation to a user equipment; transmitting data based on the allocated channel resource to the user equipment; puncturing the data transmission; and assigning the punctured channel resource to another user equipment.

In a variant, the method can also include transmitting a confirmation message to the user equipment that indicates which channel resource was actually used for the data transmission.

In a variant, the method can also include receiving an indication of packet failure from the user equipment; and transmitting a retransmission grant message that indicates which part of channel resource previously granted was not used for the data transmission.

In a variant, the retransmission grant message assigns only previously punctured channel resource as retransmission resource.

According to third and fourth embodiments, an apparatus can include means for performing the method according to the first and second embodiments respectively, in any of their variants.

According to fifth and sixth embodiments, an apparatus can include at least one processor and at least one memory and computer program code. The at least one memory and the computer program code can be configured to, with the at least one processor, cause the apparatus at least to perform the method according to the first and second embodiments respectively, in any of their variants.

According to seventh and eighth embodiments, a computer program product may comprise a computer readable medium bearing computer program code for performing a process including the method according to the first and second embodiments respectively, in any of their variants.

According to ninth and tenth embodiments, a non-transitory computer readable medium may store instructions that, when executed in hardware, perform a process including the method according to the first and second embodiments respectively, in any of their variants.

According to eleventh and twelfth embodiments, a system may include at least one apparatus according to the third or fifth embodiments in communication with at least one apparatus according to the fourth or sixth embodiments, respectively in any of their variants.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example flexible time-frequency scheduling and frame structure.

FIG. 2 illustrates an example communication system in which various example embodiments of the application implement.

FIG. 3 describes the principle of puncturing or “stealing” physical resources from a scheduled UE and giving the resources to another higher priority user as an example embodiment.

FIG. 4 illustrates introduction of postamble to contain a resource allocation confirmation message in accordance with an example embodiment of the application.

FIG. 5 illustrates introduction of additional hybrid automatic repeat request (HARQ) grant information on the validity of the previous grant in accordance with an example embodiment of the application.

FIGS. 6a and 6b illustrate flowcharts in accordance with various example embodiments of the application.

FIG. 7 illustrates a simplified block diagram of various example apparatuses that are suitable for use in practicing various example embodiments of this application.

### DETAILED DESCRIPTION

In the 3^{rd} Generation Partnership Project (3GPP) upcoming 5G system, the system may support a number of use cases and features. These use cases are, but not limited to: mobile broadband (MBB), massive machine type communication (MMC), and mission critical communication (MCC). Each of these use cases has different requirement on the system to be designed, and in order to support such diverse use cases, a relatively flexible scheduling and frame structure may be needed, which allows for a number of different UE configurations to co-exist within the same radio access technology.

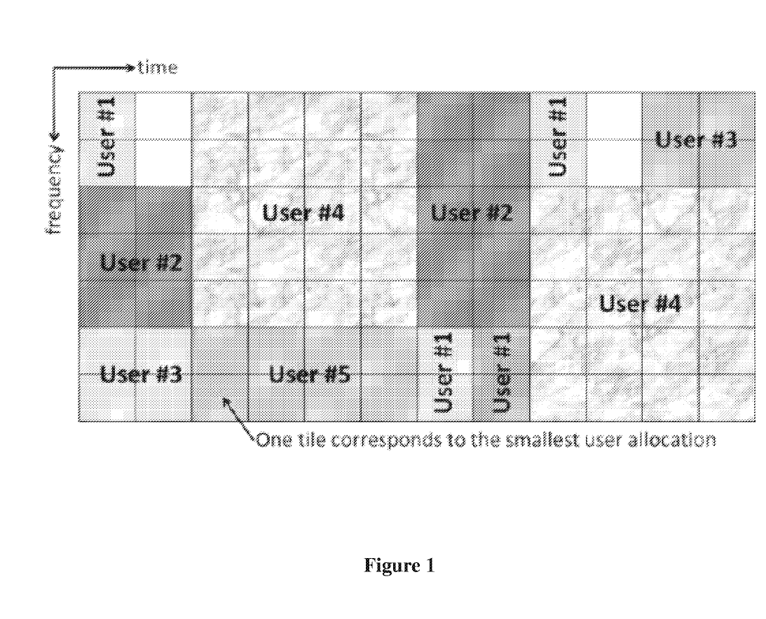

To illustrate the flexible scheduling and frame structure, we use the exemplary layout of the time-frequency grid as shown in FIG. 1. In the example embodiment of FIG. 1, users being scheduled in the system can be served with variable time and frequency allocations. In the figure, we have shown three possibilities for allocations in time: short transmit time interval (TTI), medium TTI and long TTI. The flexible scheduling and frame structure will allow for users with shorter and longer TTIs to be multiplexed within the same physical layer structure. As can be seen in the exemplary layout of FIG. 1, we have a number of users (named from user #1 to user #5), where user #1 is having a very short TTI, while users #4 and #5 are using much longer TTI sizes. Users #2 and #3 are having a TTI size in-between.

FIG. 1 should be seen as illustrative in nature. In a practical realization of the 5G system there may be just two TTI sizes used due to less testing options for the devices in the network. It should also be noted that the users are illustrated being scheduled on frequency-contiguous resources in FIG. 1, while a realistic implementation may be allocating resources using disjoint frequency resources.

In an example embodiment, it is assumed that the time-wise scheduling of the user equipment (UE) is typically controlled by a scheduling node, such as for example, an access point, a base station or an evolved Node B (eNB), or a master UE in the scenario of device-to-device or machine-to-machine communication, and that the scheduling node will be able to dynamically adjust the TTI sizes being used towards each UE depending on the service needs. The short TTI is efficient for low latency and low volume scheduling, while the longer TTIs are efficient for enhancing the spectral efficiency through lower control channel overhead. The longer TTIs may typically also provide better coverage possibilities.

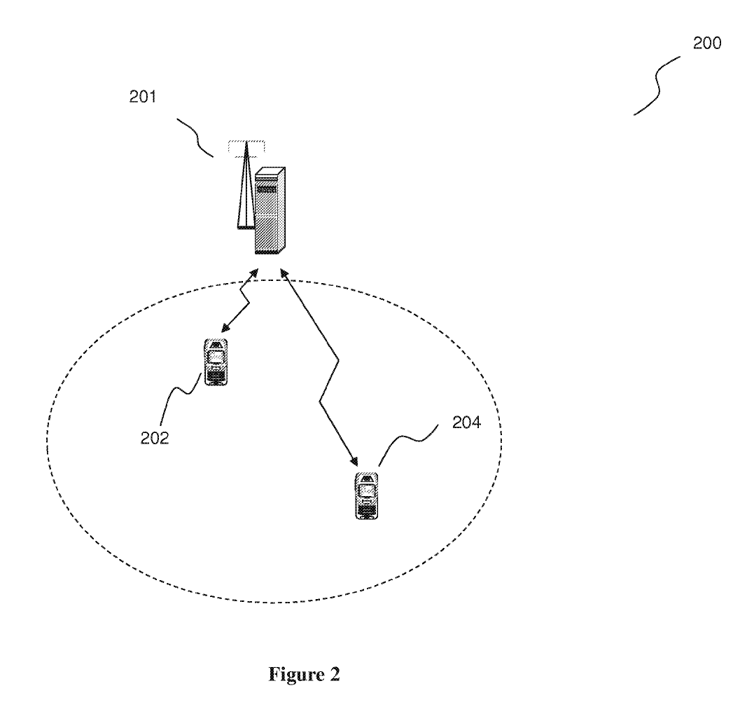

FIG. 2 illustrates an example communication system 200 in accordance with an example embodiment of the application in which the flexible scheduling and frame structure can be implemented. The example communication system 200 comprises a network element (NE) 201, such as for example, a 3GPP macro cell eNB connecting to a core network that is not shown for brevity. In an example scenario, the NE 201 serves two UEs 202 and 204. In this example, the UEs 202 and 204 may be assigned a short TTI and a long TTI, respectively, due to their different service requirements. Although just one NE and two UEs are shown in FIG. 2, it is only for the purpose of illustration and the example communication system 200 may comprise any number of NE(s) and UE(s).

The introduction of variable TTI size to accommodate different service requirements may potentially create a conflict, since using long TTI will also create a time-wise commitment to the physical resources available for the duration of the TTI. For example, in case a UE, such as for example, the UE 204 of FIG. 2, is scheduled for a 4 ms transmission in the full bandwidth, the UE is expecting to receive a data transmission for the entirety of the 4 ms being scheduled. If, during this period of time, a high priority and/or low latency packet for another UE, such as for example, the UE 202 of FIG. 2, is received in the scheduling node, such as for example, the NE 201 of FIG. 2, or a master UE, it may not be scheduled until the transmission for the already scheduled UE 204 has been completed. One way to address this problem is to reserve some physical resources (for example, some time/frequency resources) for high priority and/or low latency data transmissions, but pre-allocating such resources would reduce the scheduling flexibility and performance of the system, since there would always need to be some resources allocated for this purpose. Basically, splitting resources into smaller pools would be resulting in a loss of trunking efficiency.

In an example embodiment, a high priority/low latency UE may monitor the radio channel resources for scheduling information, and in case there is a scheduling grant for the UE, the UE will simply start receiving the allocated data. If the scheduled channel resource is part of what has already been scheduled to another low priority/high latency UE with a long TTI, it means that the long TTI transmission of the other UE is punctured in favor of higher priority data arriving at the scheduling node.

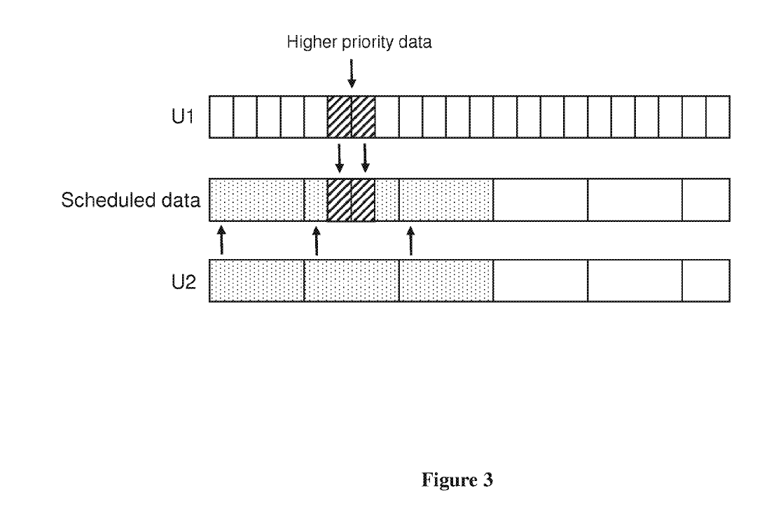

FIG. 3 describes the principle of puncturing or “stealing” physical resources from a scheduled UE and giving the resources to another higher priority user as an example embodiment. In FIG. 3, two users in queue, such as for example, the UEs 202 and 204 of FIG. 2, are scheduled by a scheduling node, such as for example, the NE 201 of FIG. 2, or a master UE. For illustrational purposes we are illustrating these two users on each side of the actual scheduling decision, which is placed in the center line of the figure. In case there is data scheduled for any of the users, the data block is transferred to the “scheduled data” line. As can be seen, user 2 (U2) is scheduled with long TTI duration (for example, for maintaining high spectral efficiency). However, at some time instant, user 1 (U1) has some high priority data that cannot wait until the completion of the ongoing U2 transmission, so the transmission towards U2 will have to be partly punctured.

In an example embodiment, in order to reduce the impact on the victim UE (i.e. the UE with a punctured data transmission), certain signaling may be provided to make the victim UE aware of the puncturing of transmission. Such signaling between the scheduling node and the impacted UE (the victim UE) may need to be explicit for the UE such that it knows that the data transmission has been punctured.

In an example embodiment, no explicit signalling is defined for victim UE. A victim UE with partly punctured transmission may either not be aware that a particular part of the resources are cancelled and contains no valid signal for it, or only be aware if able to deduce by other means, such as for example, being able to decode the scheduling grant (SG) for the higher priority UE, or noticing that the demodulation reference signal (DM-RS) for the punctured resources looks significantly different, or similar approach or combination of the above. In an example embodiment, UE specific DM-RS may be designed to assist the estimation procedure for the puncturing pattern.

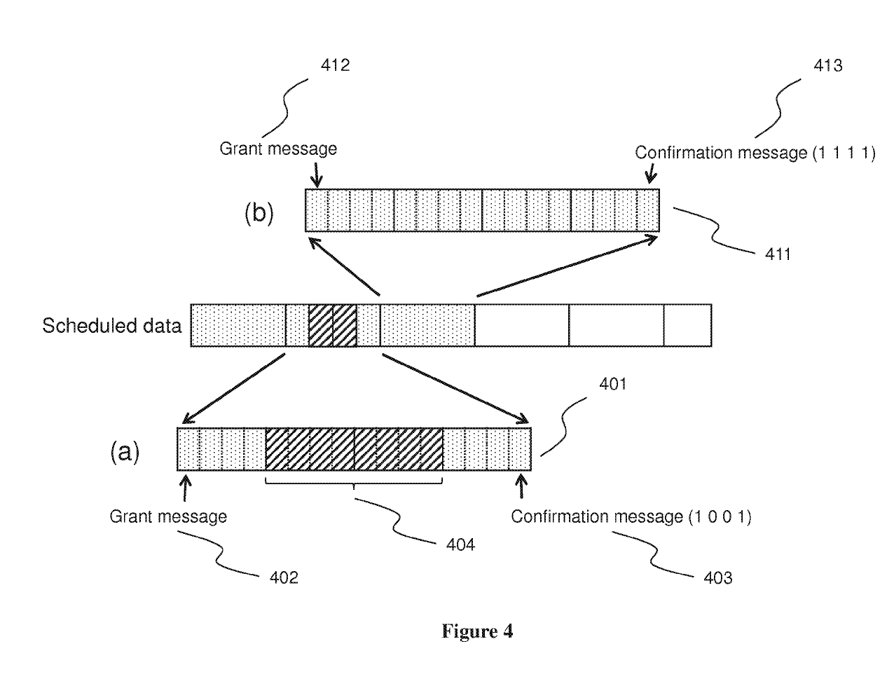

In an example embodiment, a postamble with indication of which resources were actually used for the transmission is introduced. This approach may be seen as a split control signalling approach where the initial grant prior to the data transmission will contain the intention of scheduled resources from the scheduling node side, while the postamble will contain a confirmation of which resources were actually used for this UE. Examples of such solution for the postamble are shown in FIG. 4. For illustration purpose, it is assumed that the scheduled data is transmitted in data frames and one frame may include four transmission blocks, while each transmission block may be further divided into four sub-blocks. In example (a) of FIG. 4, an initial grant message 402 is transmitted prior to or at the beginning of the scheduled data frame 401. After the initial grant message, two transmission blocks 404 have been given to another higher priority/shorter TTI UE. This puncturing of scheduled resource is indicated in the confirmation message 403 transmitted at the end or after the transmission of data frame 401, by indicating a “0” for the corresponding invalid or punctured physical resources, which in this example are the second and the third transmission blocks. In example (b), for scheduled data frame 411, after the initial grant message 412, no resources have been re-allocated to other user, and hence there is no “0” indications in the confirmation message 413. From the figure it can be seen that the introduction of the postamble will allow the UE to detect the actual allocation grant pattern prior to detecting and demodulating the data in the receiver. In principle, it may also be possible to split the confirmation message into a set of separate confirmation messages belonging to each of the transmission blocks or even sub-blocks, but such solution may be a bit in conflict with the general understanding that each of the scheduling units would be reserved for each UE. In case of using such an approach, each transmission block or sub-block may carry its own confirmation message, and thereby it might be difficult to separate confirmation messages from U1 and U2 respectively. Further, in case the confirmation message is split into smaller segments, the decoding reliability may become a problem, because it may be difficult to reliably detect the validity of a single bit transmission.

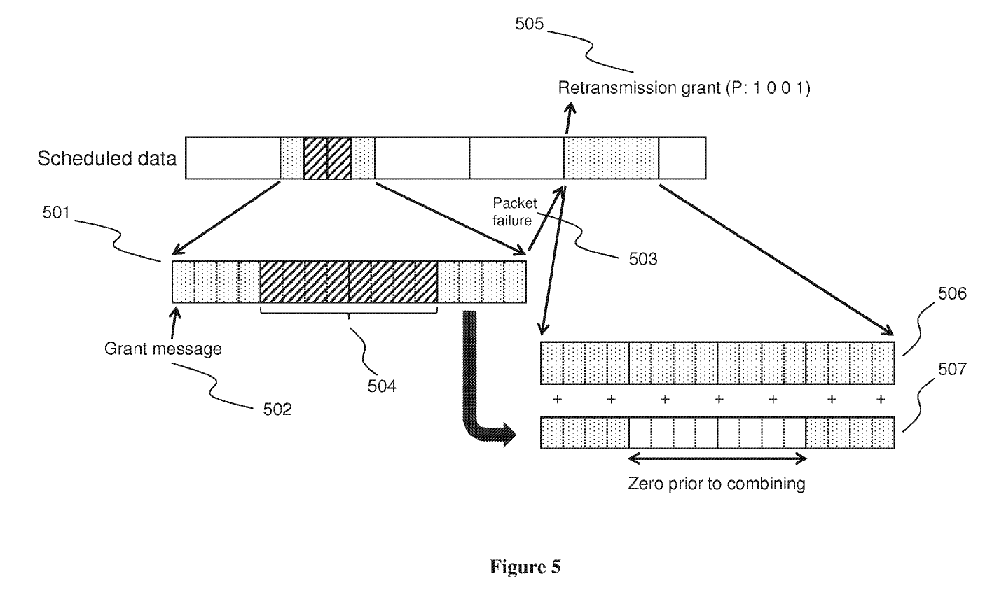

In an example embodiment, certain information indicating which resources were rescheduled to another UE may be provided in the hybrid automatic repeat request (HARQ) scheduling grant. As the temporary interruption or termination of transmission of a victim UE for a higher priority UE may likely cause a reception failure for the victim UE, the scheduling node may need to do a retransmission. In order to improve the detection reliability for HARQ combined packet it is crucial for the victim UE to know which parts of the previously received signal was actually intended for itself. The principle of conveying additional information in retransmission grant is outlined in FIG. 5.

In the example of FIG. 5, an initial grant message 502 is transmitted prior to or at the beginning of the scheduled data frame 501. After the initial grant message, two transmission blocks 504 have been given to another higher priority/shorter-TTI UE. Such puncturing of the radio resources originally assigned to the victim UE may result in an incorrect data reception and an indication of packet failure 503 may be sent by the victim UE to the scheduling node, such as for example, an eNB. The eNB then schedules a retransmission and transmits a retransmission grant 505 towards the victim UE. The retransmission grant 505 may include information indicating the puncturing pattern of the resources in the previous transmission. For example, a “0” means a corresponding invalid or punctured transmission block and a “1” means a corresponding valid or actually used transmission block in the previous transmission. After receiving the retransmitted data frame 506, the victim UE may perform the HARQ combining. As the UE now gets information on the status of the previous interruption of data transmission, it can exclude the data received in the previous transmission that was for another UE from the HARQ soft combining process as shown in 507 and ensure that the estimation of the transmitted data is based on information solely intended for the victim UE itself.

In an example embodiment, the retransmission may be limited to only contain data from the punctured resources. In this case, the scheme may be targeting “resource filling” rather than recovery from channel impairments. This variant may be for cases where the modulation coding scheme for the original transmission has been selected to guarantee that the first transmission would be successful.

In an example embodiment, the signalling mentioned above may be combined for more robustness.

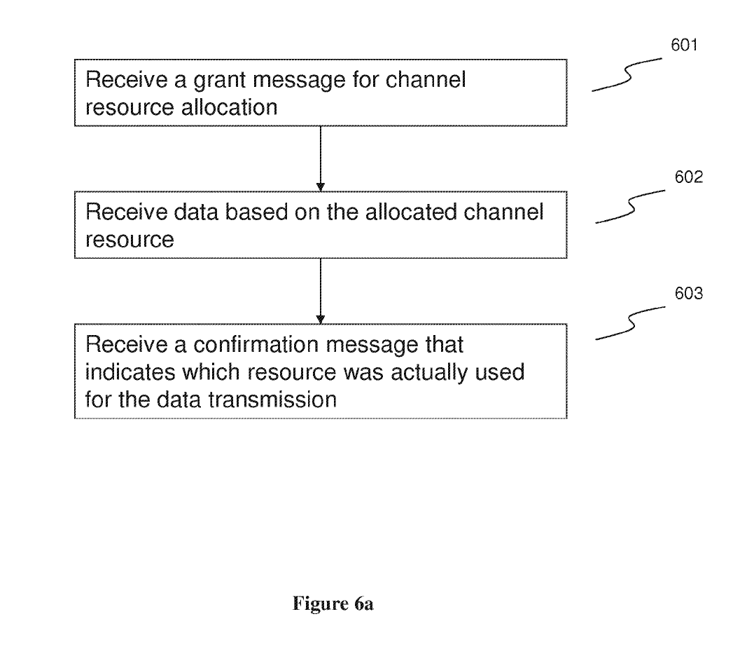

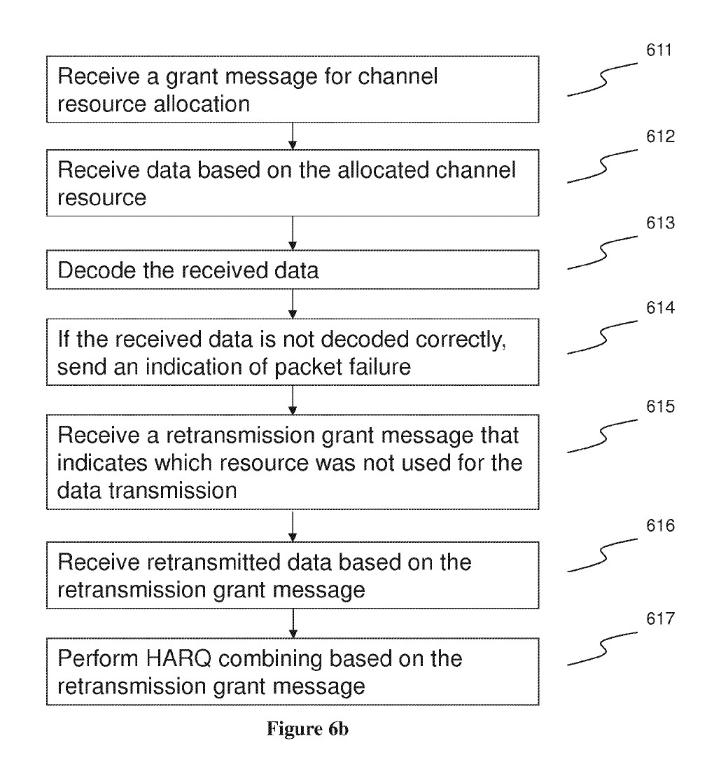

FIG. 6a illustrates a flowchart in accordance with an example embodiment of the application. In the example of FIG. 6a, a UE, such as for example, the UE 202 or 204 of FIG. 2, receives at step 601 a grant message for channel resource allocation from a scheduling node, such as for example, the NE 201 of FIG. 2, or a master UE. At step 602, the UE receives data transmission based on the allocated channel resource from the scheduling node. The UE may also receives a confirmation message at step 603 from the scheduling node that indicates which channel resource was actually used for the data transmission.

FIG. 6b illustrates a flowchart in accordance with an example embodiment of the application. In the example of FIG. 6b, a UE, such as for example, the UE 202 or 204 of FIG. 2, receives at step 611 a grant message for channel resource allocation from a scheduling node, such as for example, the NE 201 of FIG. 2, or a master UE. At step 612, the UE receives data transmission based on the allocated channel resource from the scheduling node. At step 613, the UE decodes the received data. If the received data cannot be decoded correctly, the UE may send an indication of packet failure to the scheduling node at step 614, which will trigger a retransmission procedure where the scheduling node will allocate channel resource in a retransmission grant message for data retransmission. The retransmission grant message may also include indication showing which resource in the previous transmission was not used for this UE. The UE receives the retransmission grant message at step 615 and receives the retransmitted data at step 616. Based on the indication provided in the retransmission grant message, the UE performs HARQ combining at step 617.

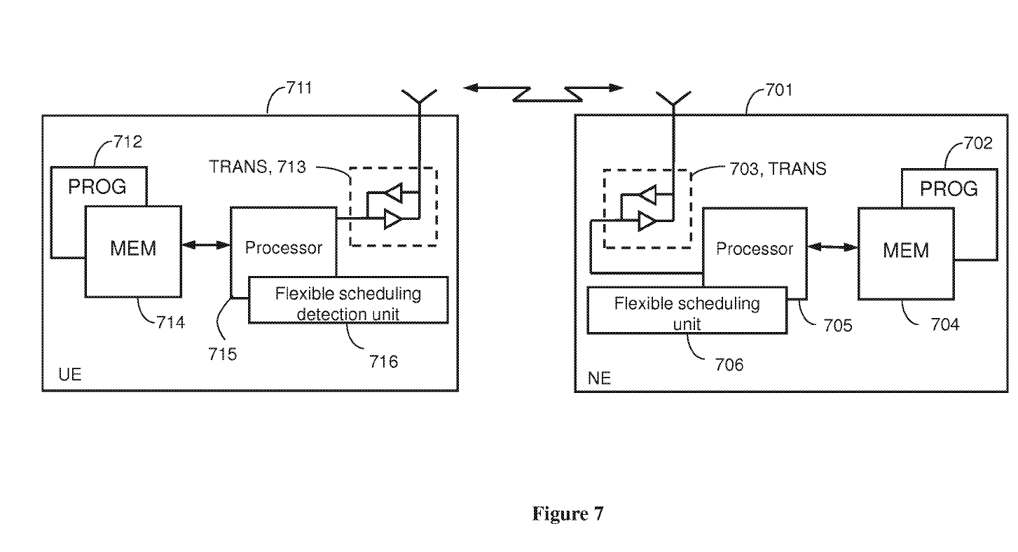

Reference is made to FIG. 7 for illustrating a simplified block diagram of various example apparatuses that are suitable for use in practicing various example embodiments of this application. In FIG. 7, a network element, NE, 701, such as for example, the NE 201 of FIG. 2, is adapted for communication with a UE 711, such as for example, the UE 202 or 204 of FIG. 2. The UE 711 includes at least one processor 715, at least one memory (MEM) 714 coupled to the at least one processor 715, and a suitable transceiver (TRANS) 713 (having a transmitter (TX) and a receiver (RX)) coupled to the at least one processor 715. The at least one MEM 714 stores a program (PROG) 712. The TRANS 713 is for bidirectional wireless communications with the NE 701.

The NE 701 includes at least one processor 705, at least one memory (MEM) 704 coupled to the at least one processor 705, and a suitable transceiver (TRANS) 703 (having a transmitter (TX) and a receiver (RX)) coupled to the at least one processor 705. The at least one MEM 704 stores a program (PROG) 702. The TRANS 703 is for bidirectional wireless communications with the UE 711. The NE 701 may be coupled to one or more cellular networks or systems, which is not shown in this figure.

As shown in FIG. 7, the NE 701 may further include a flexible scheduling unit 706.

The unit 706, together with the at least one processor 705 and the PROG 702, may be utilized by the NE 701 in conjunction with various example embodiments of the application, as described herein.

As shown in FIG. 7, the UE 711 may further include a flexible scheduling detection unit 716. The unit 716, together with the at least one processor 715 and the PROG 712, may be utilized by the UE 711 in conjunction with various example embodiments of the application, as described herein.

At least one of the PROGs 702 and 712 is assumed to include program instructions that, when executed by the associated processor, enable the electronic apparatus to operate in accordance with the example embodiments of this disclosure, as discussed herein.

In general, the various example embodiments of the apparatus 711 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The example embodiments of this disclosure may be implemented by computer software or computer program code executable by one or more of the processors 705, 715 of the NE 701 and the UE 711, or by hardware, or by a combination of software and hardware.

The MEMs 704 and 714 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The processors 705 and 715 may be of any type suitable to the local technical environment, and may include one or more of general purpose computers, special purpose computers, microprocessors, digital signal processors (DSPs) and processors based on multi-core processor architecture, as non-limiting examples.

Without in any way limiting the scope, interpretation, or application of the claims appearing below, a technical effect of one or more of the example embodiments disclosed herein may be multiplexing more efficiently users with different requirements and TTI sizes on the same shared channel. In particular, it offers the possibility of having scheduled time-critical data on resources already granted for less critical data transmissions. By allowing this partial scheduling puncturing (SP) of the less critical transmission, more efficient use of the common resources is achieved, resulting in overall better system performance. Another technical effect may be, with additional explicit indication to the victim user having part of its scheduling cancelled, offering a powerful mechanism for minimizing the undesirable effect of part of its transmission “destroyed”.

Embodiments of the present invention may be implemented in software, hardware, application logic or a combination of software, hardware and application logic. The software, application logic and/or hardware may reside on an apparatus such as a user equipment, an eNB or other mobile communication devices. If desired, part of the software, application logic and/or hardware may reside on a NE 701, part of the software, application logic and/or hardware may reside on a UE 711, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a non-transitory computer-readable storage medium that may be any media or means that can contain or store the instructions for use by or in connection with an instruction execution system, apparatus, or device.

It is also noted herein that while the above describes example embodiments of the invention, these descriptions should not be viewed in a limiting sense. Rather, there are several variations and modifications which may be made without departing from the scope of the present invention. For example, the general SP control signalling indicates the puncturing of certain time-frequency resources. Although only options for time-wise indications are illustrated above in various example embodiments, similar solution in the frequency domain can be obtained by applying the same principle. Moreover, although 5G system is used as example system in which various example embodiments of the application implement, it should be noted that the invention can be applied to a number of radio access technologies. It is also noted that in several variations and modifications of the present invention, the lower priority packet and higher priority packet may belong to the same UE, though this would require the UE to have two different monitoring patterns to implement the flexible scheduling mechanism.

Further, the various names used for the described parameters are not intended to be limiting in any respect, as these parameters may be identified by any suitable names.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

1-13. (canceled)

14. A method comprising:
receiving a grant message for a channel resource allocation from a scheduling node;
receiving data transmission based on the channel resource allocation from the scheduling node; and
determining whether the data transmission has been punctured.

15. The method according to claim 14, further comprising receiving a confirmation message from the scheduling node that indicates which part of the channel resource allocation was actually used for the data transmission, wherein determining whether the data transmission has been punctured comprises determining based on the received confirmation message.

16. The method according to claim 14, further comprising:
decoding the received data transmission;
if the received data is not decoded correctly, sending an indication of packet failure to the scheduling node; and
receiving a retransmission grant message that indicates which part of the channel resource allocation previously granted was not used for the data transmission, wherein determining whether the data transmission has been punctured comprises determining based on the received retransmission grant message.

17. The method according to claim 16, further comprising:
receiving retransmitted data and performing hybrid automatic repeat request combining based on the retransmission grant message.

18. The method according to claim 16, wherein the retransmission grant message assigns only previously punctured channel resource as a retransmission resource.

19. A method comprising:
transmitting a grant message for a channel resource allocation to a user equipment;
transmitting data based on the channel resource allocation to the user equipment;
puncturing the data transmission; and
assigning the punctured part of the channel resource allocation to another user equipment.

20. The method according to claim 19, further comprising transmitting a confirmation message to the user equipment that indicates which part of the channel resource allocation was actually used for the data transmission.

21. The method according to claim 19, further comprising:
receiving an indication of packet failure from the user equipment; and
transmitting a retransmission grant message that indicates which part of the channel resource allocation previously granted was not used for the data transmission.

22. The method according to claim 21, wherein the retransmission grant message assigns only previously punctured channel resource as a retransmission resource.

23. An apparatus, comprising:
at least one processor; and
at least one memory including computer program code,
wherein the at least one memory and the computer program code are configured to, with the at least one processor, cause the apparatus at least to
receive a grant message for a channel resource allocation from a scheduling node;
receive data transmission based on the channel resource allocation from the scheduling node; and
determine whether the data transmission has been punctured.

24. The apparatus according to claim 23, wherein the at least one memory and the computer program code are configured to, with the at least one processor, cause the apparatus further to receive a confirmation message from the scheduling node that indicates which part of the channel resource allocation was actually used for the data transmission, wherein determining whether the data transmission has been punctured is based on the received confirmation message.

25. The apparatus according to claim 23, wherein the at least one memory and the computer program code are configured to, with the at least one processor, cause the apparatus further to:
decode the received data transmission;
if the received data is not decoded correctly, send an indication of packet failure to the scheduling node; and
receive a retransmission grant message that indicates which part of the channel resource allocation previously granted was not used for the data transmission, wherein determining whether the data transmission has been punctured is based on the received retransmission grant message.

26. The apparatus according to claim 25, wherein the at least one memory and the computer program code are configured to, with the at least one processor, cause the apparatus further to:
receive retransmitted data and perform hybrid automatic repeat request combining based on the retransmission grant message.

27. The apparatus according to claim 25, wherein the retransmission grant message assigns only previously punctured channel resource as a retransmission resource.

28. An apparatus, comprising:
at least one processor; and
at least one memory including computer program code,
wherein the at least one memory and the computer program code are configured to, with the at least one processor, cause the apparatus at least to:
transmit a grant message for a channel resource allocation to a user equipment;
transmit data based on the channel resource allocation to the user equipment;
puncture the data transmission; and
assign the punctured part of the channel resource allocation to another user equipment.

29. The apparatus according to claim 28, wherein the at least one memory and the computer program code are configured to, with the at least one processor, cause the apparatus further to transmit a confirmation message to the user equipment that indicates which part of the channel resource allocation was actually used for the data transmission.

30. The apparatus according to claim 28, wherein the at least one memory and the computer program code are configured to, with the at least one processor, cause the apparatus further to:
receive an indication of packet failure from the user equipment; and
transmit a retransmission grant message that indicates which part of channel resource allocation previously granted was not used for the data transmission.

31. The apparatus according to claim 30, wherein the retransmission grant message assigns only previously punctured channel resource as a retransmission resource.

32. A non-transitory computer readable medium comprising program instructions for causing an apparatus to perform at least the following:
receiving a grant message for a channel resource allocation from a scheduling node;
receiving data transmission based on the channel resource allocation from the scheduling node; and
determining whether the data transmission has been punctured.

33. A non-transitory computer readable medium comprising program instructions for causing an apparatus to perform at least the following:
transmitting a grant message for a channel resource allocation to a user equipment;
transmitting data based on the channel resource allocation to the user equipment;
puncturing the data transmission; and
assigning the punctured part of the channel resource allocation to another user equipment.
